(19) United States
(12) Patent Application Publication
(10) Pub. No.: US 2007/0201475 A1
(43) Pub. Date: Aug. 30, 2007

(54) PACKET PROCESSING SYSTEM AND RELATED PACKET PROCESSING METHOD

(76) Inventors: Kuo-Yang Li, Taipei Hsien (TW); Tzuo-bo Lin, Taipei City (TW); Hsu-Jung Tung, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/674,154

(22) Filed: Feb. 13, 2007

(30) Foreign Application Priority Data
Feb. 27, 2006 (TW) 095106676

(51) Int. Cl. H04L 12/56

(52) U.S. Cl. 370/392

(57) ABSTRACT

A packet processing system includes: a receiver for receiving a previous packet and a current packet through an interface; a storage device for storing the previous packet; a comparing module, coupled to the storage device and the receiver, for comparing contents of the current packet with contents of the previous packet to generate a comparison result; and a packet reading module, coupled to the storage device, for reading the contents of the current packet according to the comparison result.

### BACKGROUND OF THE INVENTION

1. Field of the Invention

The present invention relates to a packet processing system, and more particularly, to a multimedia packet processing system.

2. Description of the Prior Art

High definition multimedia interface (HDMI) has been developed from digital visual interface (DVI), where DVI is utilized for computer monitors and HDMI is utilized for digital consuming electronic products (e.g. digital TVs, DVD players, DVD recorders, set-top boxes, and other digital video and audio products). Under high resolution, HDMI can transmit high-resolution video signals, which are not compressed, and transmit audio signals.

Please refer to FIG. 1, which is a diagram of an HDMI transmitting and receiving system 100 according to the prior art. As is well known, HDMI uses a transmission minimized differential signaling (TMDS) encoding method. As shown in FIG. 1, a TMDS (Transition Minimized Differential Signaling) format has four channels, which include a clock channel and RGB color channels (e.g. TMDS channel 0, TMDS channel 1, and TMDS channel 2). In addition, the display data channel (DDC) is utilized to read the signal line of enhanced extended display identification data (E-DID), which is used for discovering the configuration and capabilities of the receiver. In this case, the transmitter 110 firstly transforms and composes video, audio and auxiliary data into the signal, which can be received by the receiver 120. Then, the transmitter 110 performs the TMDS encoding operation such that the parallel video pixel data and audio data are processed to become a series data. This allows the video data and the audio data to be transmitted in TMDS form.

In the application of HDMI, the data transmitted in the TMDS channel may be a control signal, a packet, or video data. In other words, a packet is one of the signal forms transmitted from the transmitter 110 to the receiver 120. Please refer to FIG. 2, which is a diagram of an HDMI packet according to the prior art. As shown in FIG. 2, the packet, transmitted in the three TMDS channels, can be divided into three parts, which are respectively transported in different TMDS channels. The TMDS channel 0 is utilized to transmit the packet header, which is a 4-byte data. The first 3-bytes (byte 0-byte 2) of the packet header is the content of the packet header. The last byte (byte 3) of the packet header is utilized as a parity byte.

Furthermore, the other TMDS channels (the TMDS channel 1 and the TMDS channel 2) are utilized for transmitting the packet body. The data of the packet body is assembled from the data transmitted in the channel 1 and the channel 2. The packet body comprises four sub-packets, where each sub-packet comprises 7 bytes (byte 0-byte 6) and a parity byte (shown as the parity code in FIG. 2). Therefore, a packet can carry approximately 7*4+3=31 bytes.

In addition, in the packet header, the first byte (byte 0) of the first three bytes is utilized to transmit the information of the packet type. For example, the packet can be an AVI, AUD, or MPEG packet. After the receiver 120 receives the packet, the receiver 120 can distinguish what the packet type is according to the first byte of the packet header. The packet can be stored in a proper address of a memory according to its packet type.

Generally speaking, the packet of each packet type is often transmitted more than once. For example, in the AVI standard, each image frame (or field) may carry at least one AVI packet. Furthermore, the contents of the packet are not always the same. In other words, two successive packets may carry the same contents, or different contents. In the prior art, when the receiver 120 receives a new packet, the receiver 120 needs to read the packet, however, the new packet may carry the same information as the previous packet. Obviously, the system resources are consumed if each packet carrying the same data is repeatedly read.

### SUMMARY OF THE INVENTION

It is therefore one of the primary objectives of the claimed invention to provide a packet processing system and related packet processing method, to solve the above-mentioned problem of repeatedly reading a packet having the same data as the previous packet.

According to an exemplary embodiment of the claimed invention, a packet processing module is disclosed. The packet processing module comprises: a receiving module, for receiving a current packet and a previous packet; a storage device, for storing the previous packet; a comparing module, coupled to the storage device and the receiving module, for comparing contents of the current packet with contents of the previous packet to generate a comparison result; and a reading module, coupled to the storage device, for reading the contents of the current packet according to the comparison result.

According to another exemplary embodiment of the claimed invention, a packet processing method is disclosed. The packet processing method comprises: receiving a previous packet and a current packet; storing the previous packet into a storage device; comparing contents of the previous packet with contents of the current packet to generate a comparison result; and reading the contents of the current packet according to the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an HDMI transmitting and receiving system according to the prior art.

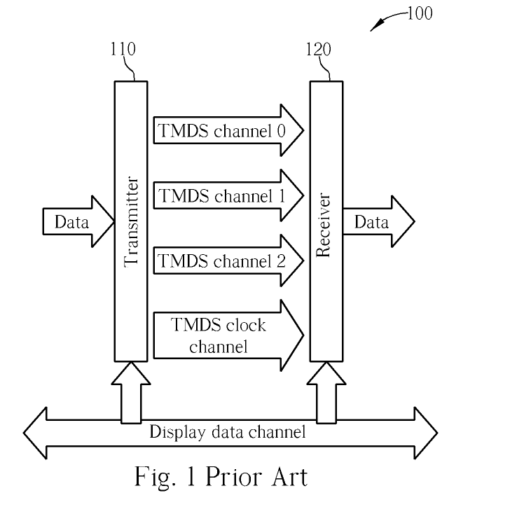

FIG. 2 is a diagram of a HDMI packet according to the prior art.

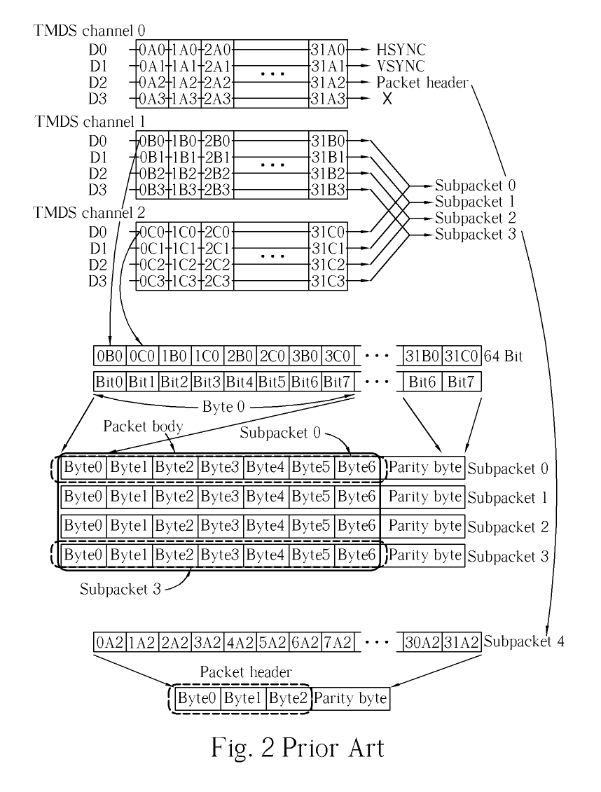

FIG. 3 is a diagram of a HDMI packet processing system of an embodiment according to the present invention.

FIG. 4 is a diagram of a packet difference detecting module and packet difference state register of an embodiment according to the present invention.

### DETAILED DESCRIPTION

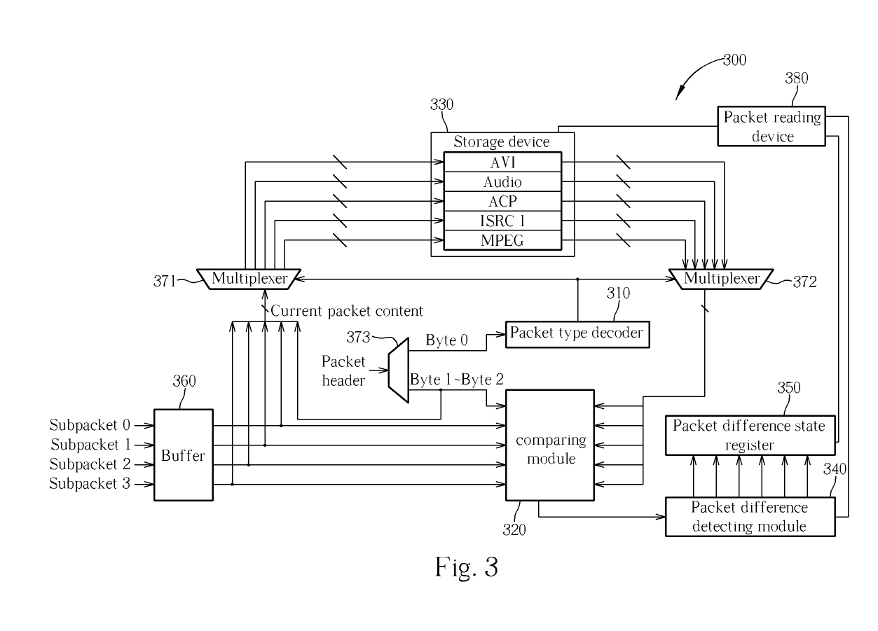

Please refer to FIG. 3, which is a diagram of an HDMI packet processing system 300 of an embodiment according to the present invention. As shown in FIG. 3, the HDMI packet processing system 300 comprises a packet type decoder 310, a comparing circuit 320, a storage device 330, a packet difference detecting module 340, a packet difference state register 350, a buffer 360, multiplexers 371, 372, 373, and a packet reading device 380. Please note that the electrical connections among the components of the HDMI packet processing system 300 have already been shown in FIG. 3, and are thus omitted here. Moreover, the function and the operation of each component will be illustrated in the following disclosure.

The storage device 330 is utilized for storing packets. In other words, all kinds of packets (e.g. AVI, ACP, AUD, ISRC1, MPEG packets shown in FIG. 3) are stored in different addresses of the storage device 330. Please note that when a packet is transmitted to the packet processing system 300 through the HDMI, either packet header or packet body, the transmitting order of the packet is byte 0, byte 1, byte 2, . . . .

First of all, the first byte (byte 0) of the packet header is transmitted to the packet type decoder 310 through the multiplexer 373 to be decoded. Therefore, the packet type of the current packet can be determined. At the same time, the first bytes (byte 0) of four sub-packets of the packet body are also transmitted to the packet processing system 300. Because the packet type has not been decoded yet, however, in this embodiment, the data is stored in a FIFO (first in first out) way inside the buffer 360 for further use.

After the packet type decoder 310 determines the packet type of the current packet, the packet type decoder 310 transmits the decoding result to the multiplexers 371 and 372. Therefore, the buffer 360 outputs the data stored inside the buffer 360 through the multiplexer 371 and the data is written into the same address of the storage device 330 (that is, the old packet having the same packet of the current packet will be overwritten by the current packet). In addition, the following two bytes (byte 1 and byte 2) of the packet header are simultaneously outputted to the storage device 330 through the multiplexer 371. The old packet, originally stored inside the storage device 330 is also simultaneously read from the storage device 330 through the multiplexer 372 and outputted to the comparing module 320.

At the same time, the following two bytes (byte 1 and byte 2) and the data stored in the buffer 360 are outputted to the comparing module 320. Therefore, the comparing module 320 compares the contents of the current packet with the contents of the old packet, which is previously stored in the storage device 330. The comparing module 320 then outputs the comparison result to the packet difference detecting module 340.

The packet difference detecting module 340 determines the value stored inside the packet difference state register 350 according to comparison result outputted by the comparing module 320. For example, if the contents of the current packet are the same as the contents of the old packet, the packet difference detecting module 340 can determine the packet difference state register 350 as 0. Otherwise, the packet difference detecting module 340 determines the packet difference state register 350 as 1. Therefore, the packet reading device 380 also has to poll the packet difference state register 350 to determine whether the current packet needs to be read or not according to the value stored inside the packet difference state register 350.

For example, if the value stored in the packet difference state register 350 is 0, it represents that the current packet is the same as the old packet and the packet reading device 350 does not have to repeatedly read the contents of the current packet. On the other hand, if the value stored in the packet difference state register 350 is 1, it represents that the contents of the current packet are different from the contents of the old packet, and the packet reading 380 therefore reads the contents of the current packet from the storage device 330.

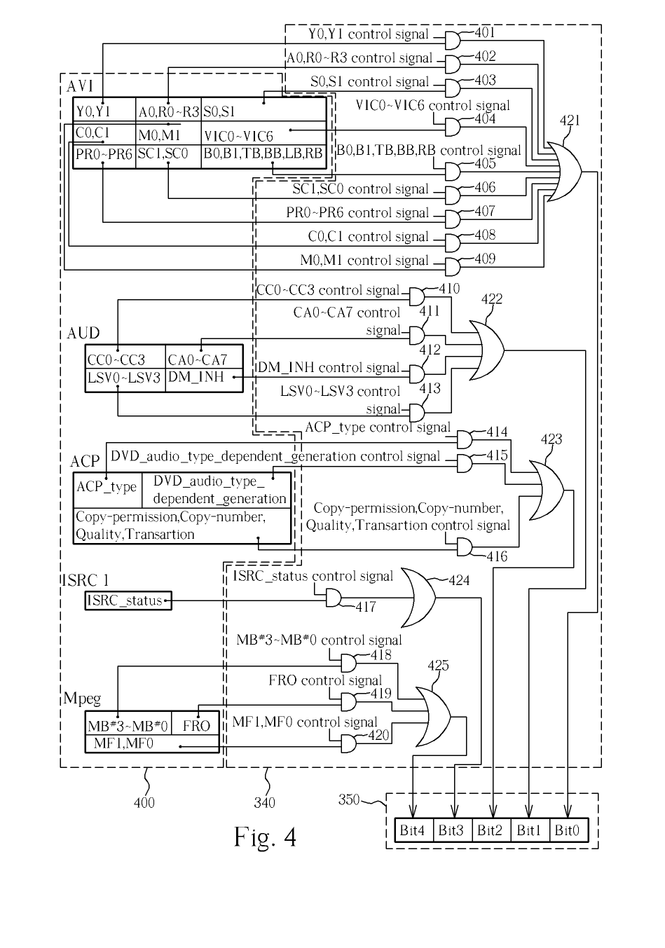

Please refer to FIG. 4, which is a diagram of a packet difference detecting module 340 and packet difference state register 350 according to one embodiment of the present invention. As shown in FIG. 4, the blocks in the dotted line 400 are the comparison result outputted by the comparing module 320. The comparison result comprises many results of different packet types (AVI, AUD, ACP, ISRC1, MPEG). Furthermore, because the packets of different packet types often carry different contents, in this embodiment, the contents of each packet are divided into several subsets. For example, the comparison of the AVI packet can be divided into 9 subsets, where each subset respectively corresponds to the comparison result of comparing a certain subset of the contents of a new AVI packet with the certain subset of the contents of the old AVI packet. Please note that the present invention does not limit the number of the subsets. In other words, the designer can determine different number of subsets according to different demands. This change also obeys the spirit of the present invention.

The packet difference detecting module 340 comprises a plurality of AND logic gates 401-420 and a plurality of OR logic gates 421-425. Please note that the output end of each OR gate corresponds to a bit of the packet difference state register 350. The input end of each OR logic gate is connected to the output ends of a plurality of AND gates. Furthermore, the input end of each AND gate receives the comparison result of a subset. For example, for the OR gate 421, the output end of the OR gate 421 is connected to a flag of the packet difference state register 350, and the input end of the OR gate 421 is connected to the output ends of 9 AND gates 401-409. The two input ends of each AND gate 401-409 are respectively connected to the comparison result of a subset of the AVI packet and a control signal.

As mentioned previously, when the comparing module 330 determines that the contents of the current packet are different from the contents of the old packet, the comparing module 330 outputs the corresponding comparison result. For example, in this embodiment, if the comparing module 330 determines that the contents of a specific subset of the current packet is different from that of the old packet, the comparison result corresponding to the specific subset is determined as logic value 1. Therefore, one of the input ends of the AND logic gate corresponds to 1.

The above-mentioned control signal is utilized to select the AND gates 401-420. For example, the control signal corresponding to the AND gate 401 has to be logic value 1, and the comparison result, inputted into the AND gate 401, can react to the output end of the AND gate 401. For the AND gates 401-420, the control signal is utilized to enable corresponding AND gates 401-420. Please note that the packet reading device 380 can determine the above-mentioned control signals to select needed subsets. For example, for the comparison results of the AVI packet, the packet reading device 380 can only determine the control signals corresponding to AND gates 401-403 as the logic value 1. Only the comparison results (Y₀, Y₁, A₀, Ro-R₃, S₀, and S₁) corresponding to the AND gates 401-403 can react to the output end of the AND gates 401˜403. The output ends of the other AND gates 404-409 always corresponds to the logic value 0 because their control signals all correspond to the logic value 0.

Because the input end of the OR gate is connected to the above-mentioned AND gates, when the output of the AND gate varies with the comparison results, the output of the OR gate also varies. The value stored inside the packet difference state register 350 is influenced by the output of the OR gate. For example, when the output of the AND gate 401 corresponds to 1 (the control signal of the AND gate 401 should be 1 at this time), the output of the OR gate 421 is obviously 1. Therefore, the flag of the bit 0 of the packet difference state register 350 is determined as 1.

Obviously, each bit of the packet difference state register 350 corresponds to the comparison result of different kinds of packets. This means that as long as the packet reading device 380 polls the packet difference state register 350, the packet reading device 380 can know whether the current packet is different from the old packet. The packet reading device 380 can decide whether the current packet should be read from the storage device 330.

Accordingly, when the packet reading device 380 intend to read the packet stored in storage device 330 according to the packet difference state register 350, the packet reading device 380 will clear the packet difference state register 350 in advance. After clearing the packet difference state register 350, packet reading device 380 still continuously inspect the content stored in the difference state register 350 to prevent the content changed during the packet reading device 380 reading the packet in storage device 330.

Please note that in the above-mentioned embodiment, the comparison result outputted by the comparing module 320 is directly inputted into the packet difference detecting module 340. The above-mentioned mechanism is only utilized as a preferred embodiment, however, not a limitation of the present invention. For example, the comparing module 320 can store the comparison result of the packet into specific places of the storage device 330 according to different packet types. Therefore, when the packet difference detecting module 340 needs to read the comparison result to set the packet difference state register 350, the packet difference detecting module 340 can read the comparison result from the specific place of the storage device 330. This change also obeys the spirit of the present invention.

Furthermore, in the above-mentioned embodiment, the comparison result is obtained through the cooperation of the packet difference detecting module 340 with the packet difference state register 350. However, in another embodiment of the present invention, only the packet difference detecting module 340 can be utilized. For example, the packet difference detecting module 340 can generate an interrupt request (IRQ) to the packet reading device 380 according to the difference between the current packet and the old packet. When receiving the IRQ, the packet reading device 380 reads the current packet stored in the storage device 330. The above-mentioned structure does not comprise the packet difference state register 350. As mentioned previously, the packet reading device 380 can also select the wanted subsets. Therefore, the packet difference detecting module 340 can generate the IRQ to the packet reading device 380 only when the contents of the selected subsets change. This change also obeys the spirit of the present invention.

Please note that the above-mentioned packet types (AVI, ACP, AUD, ISRC1, MPEG, etc.) are only utilized as an embodiment, not a limitation of the present invention. In the actual implementation, the present invention can compare the contents of a new packet with the old packet corresponding to all packet types (such as ISRC2 packets, or other self-defined packets) according to different demands.

In addition, the present invention does not limit the implementation of the packet reading device 380. In the actual implementation, the packet reading device 380 is implemented by a processor executing firmware such that the above-mentioned operations can be performed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packet processing module comprising:
a receiving module, for receiving a current packet and a previous packet;
a storage device, storing the previous packet;
a comparing module, coupled to the storage device and the receiving module, for comparing contents of the current packet with contents of the previous packet to generate a comparison result; and
a reading module, coupled to the storage device, for reading the contents of the current packet according to the comparison result.

2. The packet processing system of claim 1, further comprising:
a state register; and
a detecting module, coupled to the state register, for storing a value into the state register according to the comparison result.

3. The packet processing system of claim 2, wherein the detecting module stores a predetermined value into the state register if a subset of the contents of the current packet is different from a corresponding subset of the contents of the previous packet.

4. The packet processing system of claim 3, wherein the reading module polls the state register, and reads the current packet if the value corresponds to the predetermined value.

5. The packet processing system of claim 4, wherein before the reading module reads the contents of the current packet, the reading module clears the state register in advance.

6. The packet processing system of claim 5, wherein the subset is determined by the reading module.

7. The packet processing system of claim 1, further comprising:
a packet difference detecting module, for generating an interrupt according to the comparison result;
wherein the packet reading module reads the contents of the current packet after receiving the interrupt request.

8. The packet processing system of claim 7, wherein the detecting module generates the interrupt request if the subset of the contents of the current packet is different from the corresponding subset of the contents of the previous packet.

9. The packet processing system of claim 8, wherein the subset is determined by the reading module.

10. The packet processing system of claim 7, wherein before the reading module reads the contents of the current packet, the packet reading module clears the state register in advance.

11. The packet processing system of claim 1, wherein the storage device stores a plurality of previous packets, each corresponding to a certain packet type, and the packet processing system further comprises:
a decoding device, for determining a packet type of the current packet;
wherein the comparing module compares the current packet with a previous packet corresponding to the packet type of the current packet according to the packet type of the current packet in order to generate the comparison result.

12. The packet processing system of claim 1, wherein the packet reading module is implemented through a processor executing a firmware.

13. The packet processing system of claim 1, being utilized in a high definition multimedia interface (HDMI).

14. A packet processing method comprising:
receiving a previous packet and a current packet;
storing the previous packet in a storage device;
comparing contents of the previous packet with contents of the current packet to generate a comparison result; and
reading the contents of the current packet according to the comparison result.

15. The packet processing method of claim 14, further comprising:
storing a value to a state register according to the comparison result.

16. The packet processing method of claim 15, further comprising:
storing a predetermined value into the state register if a subset of the contents of the current packet is different from a corresponding subset of the contents of the previous packet.

17. The packet processing method of claim 15, further comprising:
clearing the state register after the contents of the current packet are read.

18. The packet processing method of claim 14, further comprising:
detecting a packet type of the current packet; and
comparing the contents of the current packet with the contents of the previous packet corresponding to the packet type of the current packet in order to generate the comparison result.

19. The packet processing method of claim 14, wherein the previous packet and the current packet are both multimedia packets.

20. The packet processing method of claim 14, being utilized in a high definition multimedia interface (HDMI).
